(19) United States
(12) Patent Application Publication
(10) Pub. No.: US 2017/0154265 A1
(43) Pub. Date: Jun. 1, 2017

(54) OPTIMIZING PREDICTIVELY CACHING REQUESTS TO REDUCE EFFECTS OF LATENCY IN NETWORKED APPLICATIONS

(71) Applicant: DATA ACCELERATOR LTD, London (GB)

(72) Inventors: Matthew P. Clothier, Somerset (GB); Robert A'Court, London (GB)

(73) Assignee: DATA ACCELERATOR LTD, London (GB)

(21) Appl. No.: 15/362,157

(22) Filed: Nov. 28, 2016

Related U.S. Application Data
(60) Provisional application No. 62/260,365, filed on Nov. 27, 2015.

(51) Int. Cl. G06N 5/02; G06N 7/00; H04L 29/08

(52) U.S. Cl. CPC G06N 5/02; H04L 67/2847; G06N 7/005; H04L 67/42

(57) ABSTRACT

A method for creating a cache by predicting database requests by an application and storing responses to the database requests is disclosed. In an embodiment, the method involves identifying a networked application having a client portion and a server portion coupled to the client portion over a network characterized by a first latency, identifying a database used to store activity related to the networked application is identified, identifying a request-response context of the networked application, using the request-response context to predict requests the networked application is likely to make using the database, using the request-response context to predict responses to the requests, creating a cache having the requests and/or the responses stored therein, and providing the cache to a predictive cache engine coupled to the client portion of the networked application by a computer-readable medium that has a second latency less than the first latency.

### BACKGROUND

Many applications include one or more client portions and one or more server portions. The client portions may interface with users, implement various functions of the application, and take actions on behalf of the application. The server portions may provide services to the client portions, provide resources for the client portions, and/or otherwise support the client portions. The client and server portions may reside on the same device, or may reside on different devices that are coupled to one another by a bus, a computer network (a Local Area Network (LAN), a Wide Area Network (WAN), the Internet, etc.), or other computer-readable medium.

Many network-based applications separate client portions and server portions from one another by a computer network. In many network-based applications, the latency of the computer network may present problems. For example, delays in processing requests from client portions or responses from server portions may adversely affect the functionalities of a network-based application. Such delays may particularly present problems in architectures that use networks with significant latency, such as a WAN, the Internet, etc. Systems and methods that address problems related to latency of a computer network that couples client portions and server portions of network-based applications would be helpful. It would also be desirable for such systems and methods to allow the resulting application to perform optimally.

### BRIEF DESCRIPTION OF THE DRAWINGS

FIG. 1 shows a block diagram of an example of a predictive caching environment.

FIG. 2 shows a block diagram of an example of a predictive cache management system.

FIG. 3 shows a block diagram of an example of a request prediction coordination engine.

FIG. 4 shows a block diagram of an example of a request-response context evaluation engine.

FIG. 5 shows a block diagram of a flowchart of an example of a method for creating a cache by predicting database requests by an application and storing responses to the database requests.

FIG. 6 shows a block diagram of a flowchart of an example of a method for identifying a request-response context of a networked application.

FIG. 7 shows a block diagram of a flowchart of an example of a method for modifying a request-response context of a networked application.

FIG. 8 shows a block diagram of an example of a computer system.

FIG. 9 is a time diagram of transaction timing in a client server transaction that takes place of a wide area connection and over a local area connection.

FIG. 10 is a timing diagram of an example of how predictive caching works for a single branch stream of a client-server application.

FIG. 11 is a timing diagram of an example of how predictive caching works for a single branch stream of a client-server application.

Throughout the description, similar reference numbers may be used to identify similar elements.

### DETAILED DESCRIPTION OF THE VARIOUS IMPLEMENTATIONS

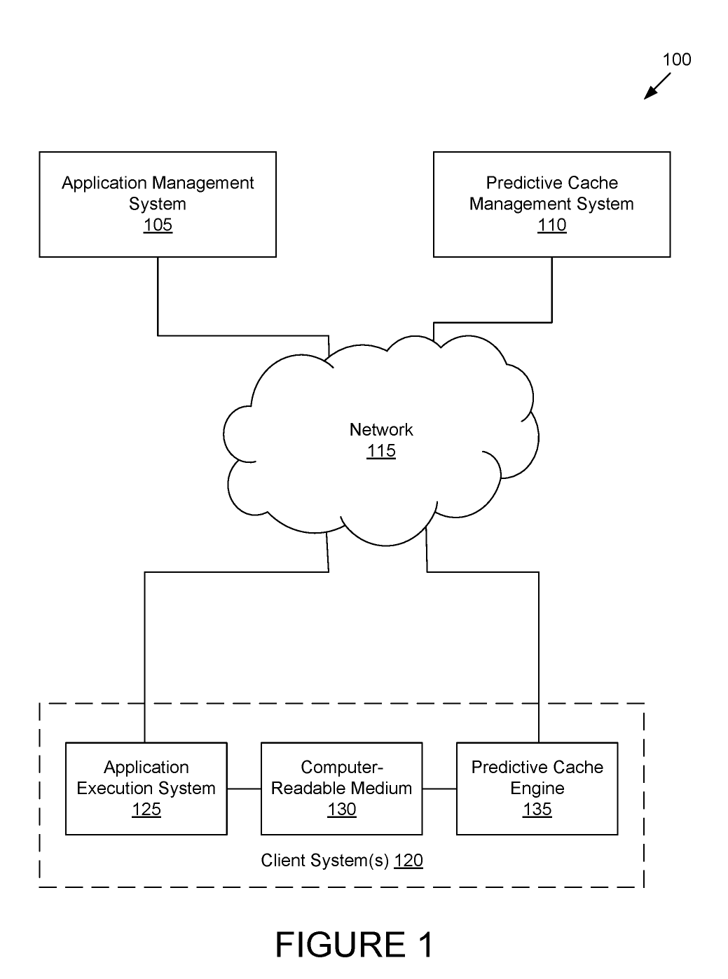

FIG. 1 shows a block diagram 100 of an example of a predictive caching environment. The diagram 100 includes an application management system 105, a predictive cache management system 110, a network 115, and one or more client systems 120 (labeled herein as “client system(s) 120”). In the example of FIG. 1, the application management system 105, the predictive cache management system 110, and the client system(s) 120 are coupled to the network 115.

The application management system 105, the predictive cache management system 110, and/or the client system(s) 120 may comprise a computer-readable medium and/or a computer system. As used in this paper, a “computer-readable medium” is intended to include all mediums that are statutory (e.g., in the United States, under 35 U.S.C. 101), and to specifically exclude all mediums that are non-statutory in nature to the extent that the exclusion is necessary for a claim that includes the computer-readable medium to be valid. Known statutory computer-readable mediums include hardware (e.g., registers, random access memory (RAM), non-volatile (NV) storage, to name a few), but may or may not be limited to hardware. The computer-readable medium 105 is intended to represent a variety of potentially applicable technologies. For example, the computer-readable medium 105 can be used to form a network or part of a network. Where two components are co-located on a device, the computer-readable medium 105 can include a bus or other data conduit or plane. Where a first component is co-located on one device and a second component is located on a different device, the computer-readable medium 105 can include a wireless or wired back-end network or LAN. The computer-readable medium 105 can also encompass a relevant portion of a WAN or other network, if applicable.

A computer system, as used in this paper, is intended to be construed broadly. In general, a computer system will include a processor, memory, non-volatile storage, and an interface. A typical computer system will usually include at least a processor, memory, and a device (e.g., a bus) coupling the memory to the processor. The processor can be, for example, a general-purpose central processing unit (CPU), such as a microprocessor, or a special-purpose processor, such as a microcontroller.

The memory can include, by way of example but not limitation, random access memory (RAM), such as dynamic RAM (DRAM) and static RAM (SRAM). The memory can be local, remote, or distributed. The bus can also couple the processor to non-volatile storage. The non-volatile storage is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software on the computer system. The non-volatile storage can be local, remote, or distributed. The non-volatile storage is optional because systems can be created with all applicable data available in memory.

Software is typically stored in the non-volatile storage. Indeed, for large programs, it may not even be possible to store the entire program in the memory. Nevertheless, it should be understood that for software to run, if necessary, it is moved to a computer-readable location appropriate for processing, and for illustrative purposes, that location is referred to as the memory in this paper. Even when software is moved to the memory for execution, the processor will typically make use of hardware registers to store values associated with the software, and local cache that, ideally, serves to speed up execution. As used herein, a software program is assumed to be stored at an applicable known or convenient location (from non-volatile storage to hardware registers) when the software program is referred to as “implemented in a computer-readable storage medium.” A processor is considered to be “configured to execute a program” when at least one value associated with the program is stored in a register readable by the processor.

In one example of operation, a computer system can be controlled by operating system software, which is a software program that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile storage and causes the processor to execute the various acts required by the operating system to input and output data and to store data in the memory, including storing files on the non-volatile storage.

The bus can also couple the processor to the interface. The interface can include one or more input and/or output (I/O) devices. The I/O devices can include, by way of example but not limitation, a keyboard, a mouse or other pointing device, disk drives, printers, a scanner, and other I/O devices, including a display device. The display device can include, by way of example but not limitation, a cathode ray tube (CRT), liquid crystal display (LCD), or some other applicable known or convenient display device. The interface can include one or more of a modem or network interface. It will be appreciated that a modem or network interface can be considered to be part of the computer system. The interface can include an analog modem, ISDN modem, cable modem, token ring interface, Ethernet interface, satellite transmission interface (e.g. “direct PC”), or other interfaces for coupling a computer system to other computer systems. Interfaces enable computer systems and other devices to be coupled together in a network.

The computer systems can be compatible with or implemented as part of or through a cloud-based computing system. As used in this paper, a cloud-based computing system is a system that provides virtualized computing resources, software and/or information to end user devices. The computing resources, software and/or information can be virtualized by maintaining centralized services and resources that the edge devices can access over a communication interface, such as a network. “Cloud” may be a marketing term and for the purposes of this paper can include any of the networks described herein. The cloud-based computing system can involve a subscription for services or use a utility pricing model. Users can access the protocols of the cloud-based computing system through a web browser or other container application located on their end user device.

A computer system can be implemented as an engine, as part of an engine or through multiple engines. As used in this paper, an engine includes at least two components: 1) a dedicated or shared processor, and 2) hardware, firmware, and/or software modules that are executed by the processor. Depending upon implementation-specific or other considerations, an engine can be centralized or its functionality distributed. An engine can include special purpose hardware, firmware, or software embodied in a computer-readable medium for execution by the processor. The processor transforms data into new data using implemented data structures and methods, such as is described with reference to the FIGS. in this paper.

The engines described in this paper, or the engines through which the systems and devices described in this paper can be implemented, can be cloud-based engines. As used in this paper, a cloud-based engine is an engine that can run applications and/or functionalities using a cloud-based computing system. All or portions of the applications and/or functionalities can be distributed across multiple computing devices, and need not be restricted to only one computing device. In some embodiments, the cloud-based engines can execute functionalities and/or modules that end users access through a web browser or container application without having the functionalities and/or modules installed locally on the end-users' computing devices.

As used in this paper, datastores are intended to include repositories having any applicable organization of data, including tables, comma-separated values (CSV) files, traditional databases (e.g., SQL), or other applicable known or convenient organizational formats. Datastores can be implemented, for example, as software embodied in a physical computer-readable medium on a specific-purpose machine, in firmware, in hardware, in a combination thereof, or in an applicable known or convenient device or system. Datastore-associated components, such as database interfaces, can be considered “part of” a datastore, part of some other system component, or a combination thereof, though the physical location and other characteristics of datastore-associated components is not critical for an understanding of the techniques described in this paper.

Datastores can include data structures. As used in this paper, a data structure is associated with a particular way of storing and organizing data in a computer so that it can be used efficiently within a given context. Data structures are generally based on the ability of a computer to fetch and store data at any place in its memory, specified by an address, a bit string that can be itself stored in memory and manipulated by the program. Thus, some data structures are based on computing the addresses of data items with arithmetic operations; while other data structures are based on storing addresses of data items within the structure itself. Many data structures use both principles, sometimes combined in non-trivial ways. The implementation of a data structure usually entails writing a set of procedures that create and manipulate instances of that structure. The datastores, described in this paper, can be cloud-based datastores. A cloud based datastore is a datastore that is compatible with cloud-based computing systems and engines.

In a specific implementation, the application management system 105 manages one or more applications executing on the client device(s) 120. The application management system 105 may correspond to a server configured to provide services to the client device(s) 120.

In a specific implementation, the predictive cache management system 110 predicts specific requests that one or more applications executing on the client device(s) 120 are likely to make during their operation. As an example, the predictive cache management system 110 may identify database requests the applications executing on the client device(s) 120 are likely to make during their operation. The predictive cache management system 110 may include one or more computer-readable media, one or more engines, and/or one or more datastores.

The network 115 may comprise a computer network characterized by a first latency. In a specific implementation, the network 115 includes a networked system including several computer systems coupled together, such as the Internet, or a device for coupling components of a single computer, such as a bus. The term “Internet” as used in this paper refers to a network of networks using certain protocols, such as the TCP/IP protocol, and possibly other protocols such as the hypertext transfer protocol (HTTP) for hypertext markup language (HTML) documents making up the World Wide Web (the web). Content is often provided by content servers, which are referred to as being “on” the Internet. A web server, which is one type of content server, is typically at least one computer system, which operates as a server computer system and is configured to operate with the protocols of the web and is coupled to the Internet. The physical connections of the Internet and the protocols and communication procedures of the Internet and the web are well known to those of skill in the relevant art. For illustrative purposes, it is assumed the network 115 broadly includes, as understood from relevant context, anything from a minimalist coupling of the components illustrated in the example of FIG. 1, to every component of the Internet and networks coupled to the Internet. In some implementations, the network 115 is administered by a service provider, such as an Internet Service Provider (ISP).

In various implementations, the network 115 can include technologies such as Ethernet, 802.11, worldwide interoperability for microwave access (WiMAX), 3G, 4G, CDMA, GSM, LTE, digital subscriber line (DSL), etc. The network 115 can further include networking protocols such as multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over network 115 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In a specific implementation, the network 115 includes a wired network using wires for at least some communications. In some implementations, the network 115 comprises a wireless network. A “wireless network,” as used in this paper can include any computer network communicating at least in part without the use of electrical wires. In various implementations, the network 115 includes technologies such as Ethernet, 802.11, worldwide interoperability for microwave access (WiMAX), 3G, 4G, CDMA, GSM, LTE, digital subscriber line (DSL), etc. The network 115 can further include networking protocols such as multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 115 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In a specific implementation, the wireless network of the network 115 is compatible with the 802.11 protocols specified by the Institute of Electrical and Electronics Engineers (IEEE). In a specific implementation, the wireless network of the network 115 is compatible with the 802.3 protocols specified by the IEEE. In some implementations, IEEE 802.3 compatible protocols of the network 115 can include local area network technology with some wide area network applications. Physical connections are typically made between nodes and/or infrastructure devices (hubs, switches, routers) by various types of copper or fiber cable. The IEEE 802.3 compatible technology can support the IEEE 802.1 network architecture of the network 115.

The client system(s) 120 include an application execution system 125, a computer-readable medium 130, and a predictive cache engine 135. The application execution system 125 and the predictive caching engine 135 may be coupled to the computer-readable medium 130. In a specific implementation, the application execution system 125 executes one or more applications supported by the application management system 105. More specifically, the application execution system 125 may include components of an application that interface with a user, perform various functionalities of the application, etc.

In a specific implementation, the computer-readable medium 130 includes a computer-readable medium that is characterized by a second latency that is less than the first latency (e.g., the latency of the network 115). In an implementation, the computer-readable medium 130 includes a networked system including several computer systems coupled together, such as the Internet, or a device for coupling components of a single computer, such as a bus. The term “Internet” as used in this paper refers to a network of networks using certain protocols, such as the TCP/IP protocol, and possibly other protocols such as the hypertext transfer protocol (HTTP) for hypertext markup language (HTML) documents making up the World Wide Web (the web). Content is often provided by content servers, which are referred to as being “on” the Internet. A web server, which is one type of content server, is typically at least one computer system, which operates as a server computer system and is configured to operate with the protocols of the web and is coupled to the Internet. The physical connections of the Internet and the protocols and communication procedures of the Internet and the web are well known to those of skill in the relevant art. For illustrative purposes, it is assumed the computer-readable medium 130 broadly includes, as understood from relevant context, anything from a minimalist coupling of the components illustrated in the example of FIG. 1, to every component of the Internet and networks coupled to the Internet. In some implementations, the computer-readable medium 130 is administered by a service provider, such as an Internet Service Provider (ISP).

In various implementations, the computer-readable medium 130 may include technologies such as Ethernet, 802.11, worldwide interoperability for microwave access (WiMAX), 3G, 4G, CDMA, GSM, LTE, digital subscriber line (DSL), etc. The computer-readable medium 130 may further include networking protocols such as multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over computer-readable medium 130 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In a specific implementation, the computer-readable medium 130 includes a wired network using wires for at least some communications. In some implementations, the computer-readable medium 130 comprises a wireless network. A “wireless network,” as used in this paper may include any computer network communicating at least in part without the use of electrical wires. In various implementations, the computer-readable medium 130 includes technologies such as Ethernet, 802.11, worldwide interoperability for microwave access (WiMAX), 3G, 4G, CDMA, GSM, LTE, digital subscriber line (DSL), etc. The computer-readable medium 130 can further include networking protocols such as multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the computer-readable medium 130 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In a specific implementation, the wireless network of the computer-readable medium 130 is compatible with the 802.11 protocols specified by the Institute of Electrical and Electronics Engineers (IEEE). In a specific implementation, the wireless network of the computer-readable medium 130 is compatible with the 802.3 protocols specified by the IEEE. In some implementations, IEEE 802.3 compatible protocols of the computer-readable medium 130 may include local area network technology with some wide area network applications. Physical connections are typically made between nodes and/or infrastructure devices (hubs, switches, routers) by various types of copper or fiber cable. The IEEE 802.3 compatible technology can support the IEEE 802.1 network architecture of the computer-readable medium 130.

In a specific implementation, the predictive cache system 135 includes engines and/or datastores configured to implement the predictive caching techniques described herein. In an implementation, the predictive cache system 135 is generated and/or managed by the predictive cache management system 110, as described further herein. The predictive cache system 135 may be generated, e.g., before deployment of the application executed by the application execution system 125. In some implementations, the predictive cache system 135 is generated during execution of the application executed by the application execution system 125. In various implementation, the predictive cache system 135 receives updates to its predictive cache from the predictive cache management system 110 after the application executed by the application execution system 125 has been deployed.

In some implementations, the predictive caching environment shown in the diagram 100 (e.g., the predictive cache management system 110) may operate to predict requests made by more applications supported by the application management system 105 and cache those predicted requests as described herein. In some implementations, the predictive caching environment shown in the diagram 100 may further operate to store a predictive cache on the client system(s) 120 (e.g., in the predictive cache engine 135) and to satisfy from the predictive cache requests by the applications supported by the application management system 105 as described herein.

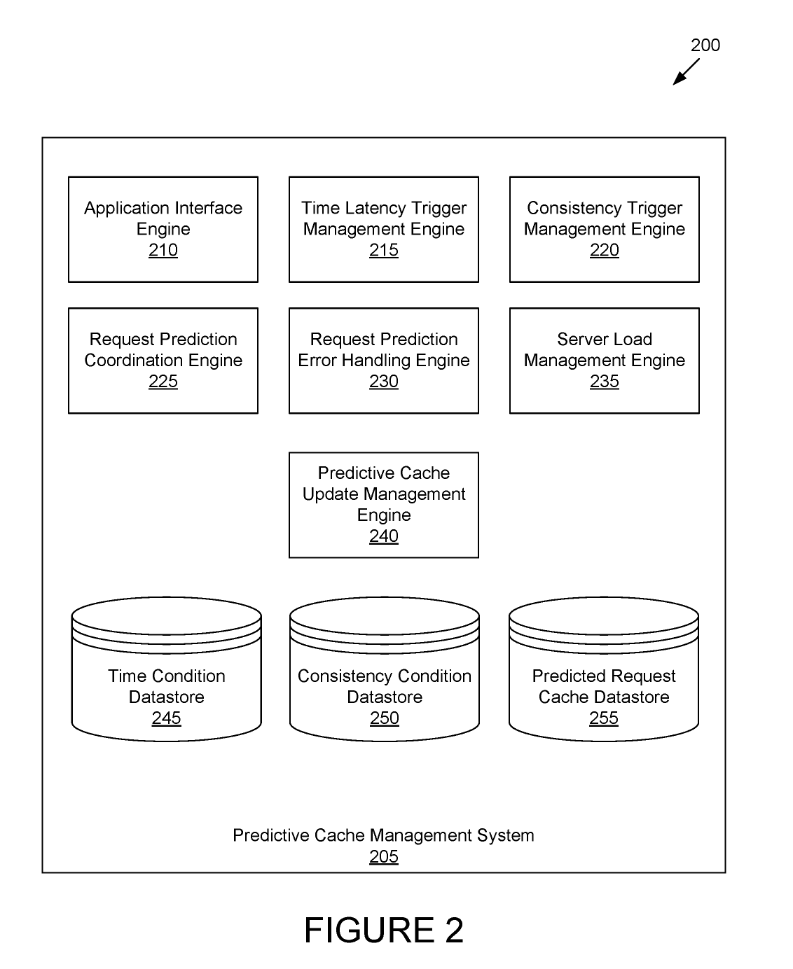

FIG. 2 shows a block diagram 200 of an example of a predictive caching management system 205. In the example of FIG. 2, the predictive caching management system 205 includes an application interface engine 210, a time latency trigger management engine 215, a consistency trigger management engine 220, a request prediction coordination engine 225, a request prediction error handling engine 230, a server load management engine 235, a predictive cache update management engine 240, a time condition datastore 245, a consistency condition datastore 250, and a predicted request cache datastore 255.

In a specific implementation, the application interface engine 210 interfaces with an application management system 105. In a specific implementation, the time latency trigger management engine 215 manages (e.g., monitors) time-based triggers that suggest latency of a network is an issue. In a specific implementation, the consistency trigger management engine 220 manages (e.g., monitors) consistency-based triggers that suggest latency of a network is an issue. In various implementations, the request prediction coordination engine 225 predicts requests (e.g., database requests) and/or responses to requests that are likely to be made during operation of an application. The request prediction coordination engine 225 may also create a predictive cache for an application, deploy the predictive cache to client system(s), and/or configure the application to use the predictive cache during operation of the application. In a specific implementation, the request prediction error handling engine 230 reduces, minimizes, etc. errors associated with predictive caching. In some implementations, the server load management engine 235 manages the effect of predictive caching on an application and/or systems used in conjunction with the predictive caching techniques described herein.

In a specific implementation, the time condition datastore 245 stores information related to time-based triggers related to latency of a network. In some implementations, the consistency condition datastore 250 stores information related to consistency-based triggers related to latency of the network. In a specific implementation, the predicted request cache datastore 255 stores a cache of predicted requests and/or responses to the predicted requests by the application.

In some implementations, the predictive caching management system 205 shown in the diagram 200 may operate to predict requests made by more applications and cache those predicted requests as described herein. In some implementations, the predictive caching management system 205 shown in the diagram 200 may further operate to store a predictive cache on client system(s) and to satisfy from the predictive cache requests by the applications as described herein.

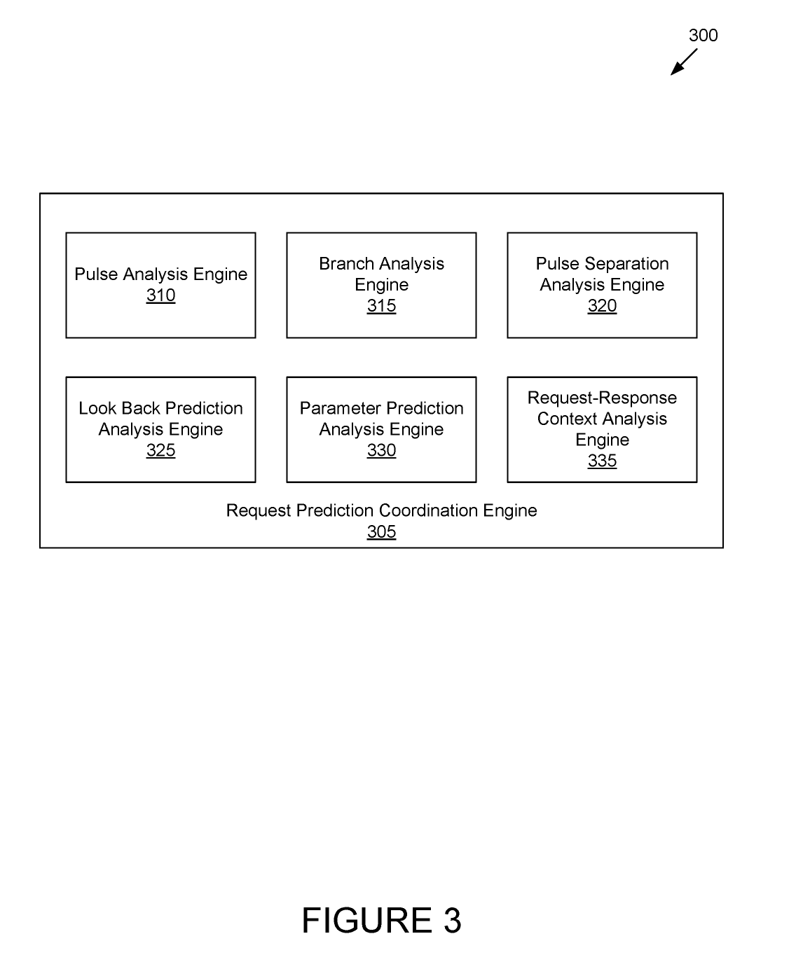

FIG. 3 shows a block diagram 300 of an example of a request prediction coordination system 305. In the example of FIG. 3, the request prediction coordination system 305 includes a pulse analysis engine 310, a branch analysis engine 315, a pulse separation analysis engine 320, a look back prediction analysis engine 325, a parameter prediction analysis engine 330, and a request-response context evaluation engine 335.

In a specific implementation, the pulse analysis engine 310 analyzes pulses to predict requests an application is likely to make and/or responses to the requests. In some implementations, the branch analysis engine 315 analyzes branches to predict requests an application is likely to make and/or responses to the requests. In various implementations, the pulse separation analysis engine 320 analyzes separations of pulses to predict requests an application is likely to make and/or responses to the requests. In a specific implementation, the look back prediction analysis engine 325 analyzes past application request/responses to predict requests an application is likely to make and/or responses to the requests. In various implementations, the parameter prediction analysis engine 330 analyzes parameters of pulses to predict requests an application is likely to make and/or responses to the requests. In a specific implementation, the request-response context evaluation engine 335 identifies a request-response context of a networked application and uses the request-response context as the basis of predicted requests by a client portion of the networked application and/or predicted responses by a server portion of the networked application.

In some implementations, the request prediction coordination system 305 shown in the diagram 300 may operate to predict requests made by more applications and cache those predicted requests as described herein. In some implementations, the request prediction coordination system 305 shown in the diagram 300 may further operate to store a predictive cache on client system(s) and to satisfy from the predictive cache requests by the applications as described herein. As discussed herein, the predicted requests and/or the predicted responses may be based on one or more request-response contexts for the networked application, as further described herein.

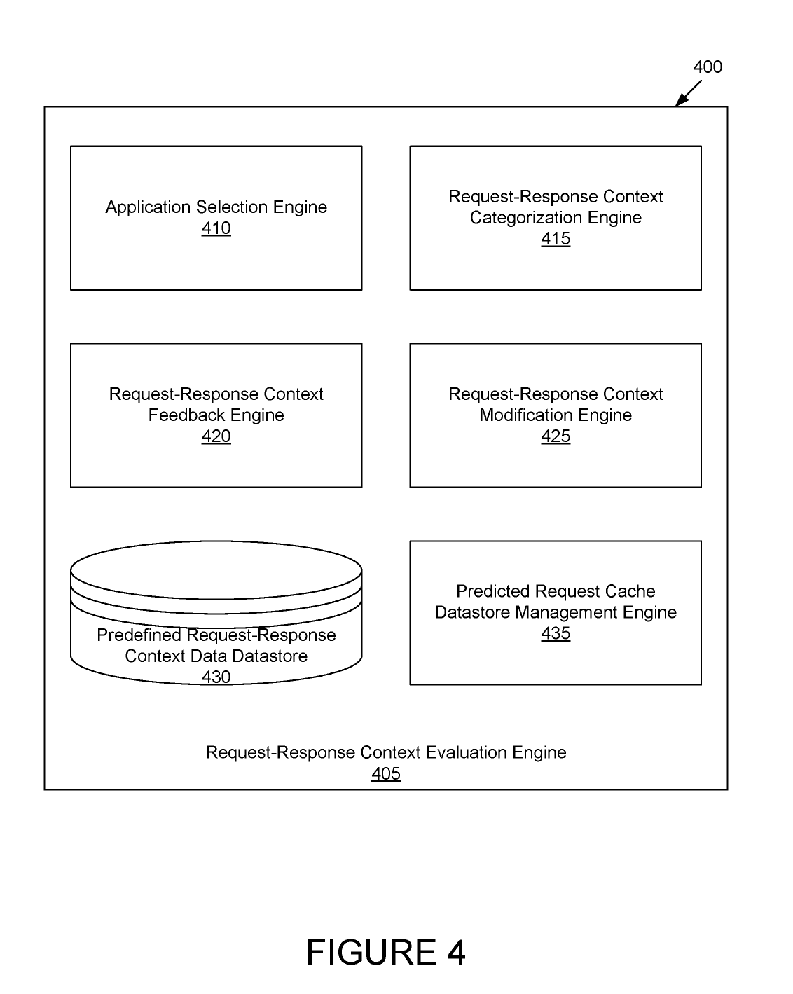

FIG. 4 shows a block diagram 400 of an example of a request-response context evaluation engine 405. In the example of FIG. 4, the request-response context evaluation engine 405 includes an application selection engine 410, a request-response context categorization engine 415, a request-response context feedback engine 420, a request-response context modification engine 425, a predefined request-response context data datastore 430, and a predicted request cache datastore management engine 435.

In some implementations, the application selection engine 410 selects a networked application and/or receives selection of a networked application for request-response context evaluation. In a specific implementation, the request-response context categorization engine 415 identifies a request-response context for an identified network application. In some implementations, the request-response context feedback engine 420 obtains feedback about actions taken by the networked application. In various implementations, the request-response modification engine 425 modifies (updates, changes, etc.) a request-response context of a networked application based on actions taken by the networked application. In a specific implementation, the predefined request-response context data datastore 430 stores data related to predefined request-response contexts used for predictive caching. In various implementations, the predicted request cache datastore management engine 435 modifies a predicted request cache datastore based on the request-response context of a networked application.

In various implementations, the request-response context evaluation engine 405 shown in the diagram 400 operates to create a predictive cache for a networked application based on a request-response context of the networked application as described herein. The request-response context evaluation engine 405 shown in the diagram 400 may further operate to identify and/or modify one or more request-response contexts of a networked application as described herein.

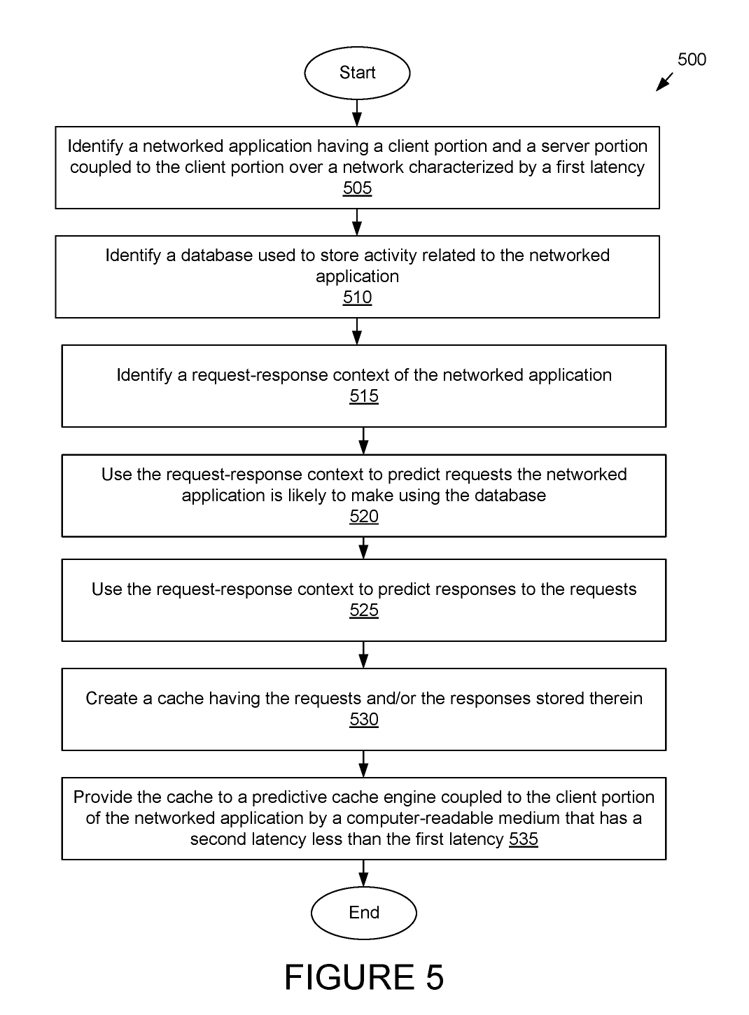

FIG. 5 shows a block diagram of a flowchart 500 of an example of a method for creating a cache by predicting database requests by an application and storing responses to the database requests. At an operation 505, a networked application having a client portion and a server portion coupled to the client portion over a network characterized by a first latency is identified. At an operation 510, a database used to store activity related to the networked application is identified. At an operation 515, a request-response context of the networked application is identified. At an operation 520, the request-response context is used to predict requests the networked application is likely to make using the database. At an operation 525, the request-response context is used to predict responses to the requests. At an operation 530, a cache having the requests and/or the responses stored therein is created. At an operation 535, the cache is provided to a predictive cache engine coupled to the client portion of the networked application by a computer-readable medium that has a second latency less than the first latency

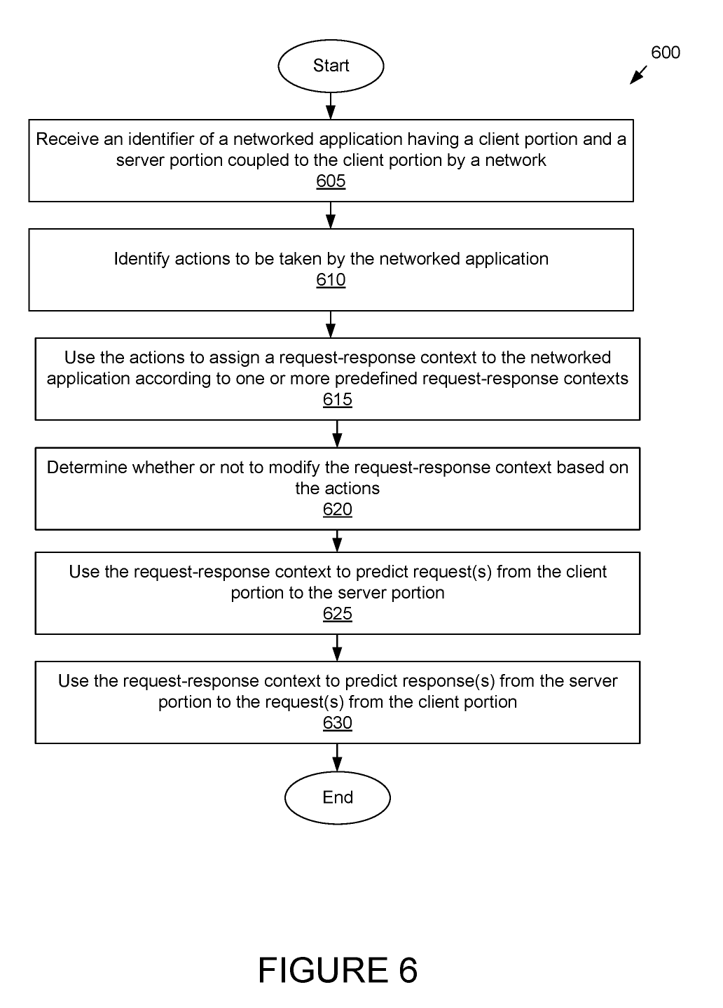

FIG. 6 shows a block diagram of a flowchart 600 of an example of a method for identifying a request-response context of a networked application. At an operation 605, an identifier of a networked application having a client portion and a server portion coupled to the client portion by a network is received. At an operation 610, actions to be taken by the networked application are identified. At an operation 615, the actions are used to assign a request-response context to the networked application according to one or more predefined request-response contexts. At an operation 620, it is determined whether or not to modify the request-response context based on the actions. At an operation 625, the request-response context is used to predict request(s) from the client portion to the server portion. At an operation 630, the request-response context is used to predict response(s) from the server portion to the request(s) from the client portion.

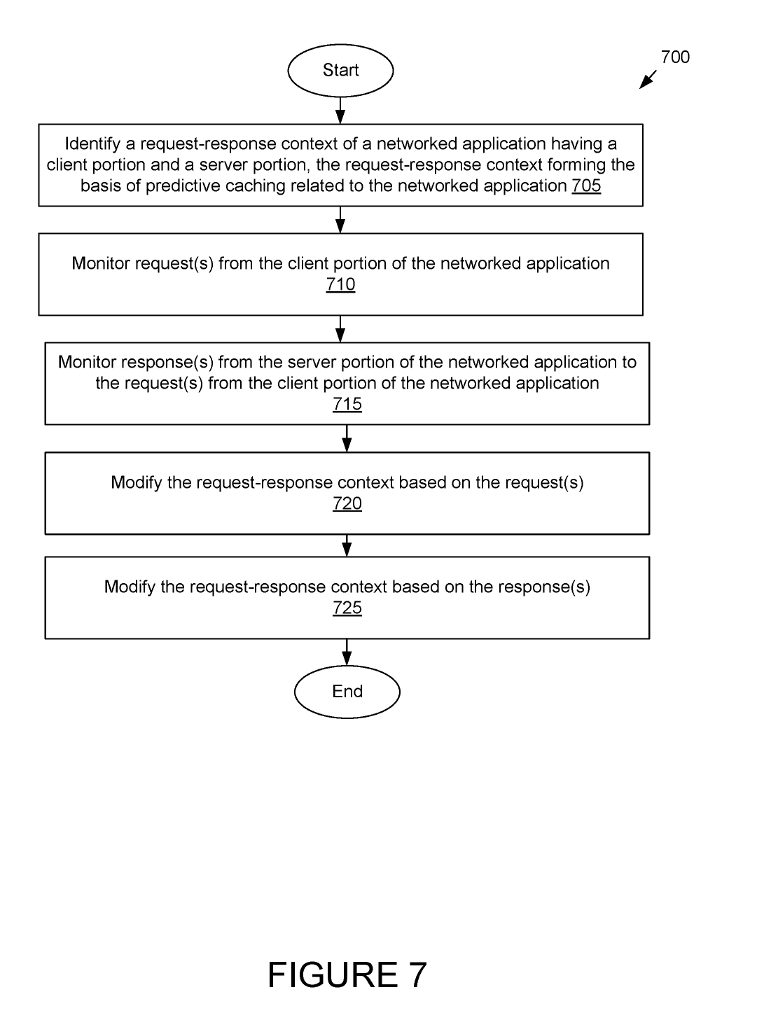

FIG. 7 shows a block diagram of a flowchart 700 of an example of a method for modifying a request-response context of a networked application. At an operation 705, a request-response context of a networked application having a client portion and a server portion is identified, where the request-response context forms a basis of predictive caching related to the networked application. At an operation 710, request(s) from the client portion of the networked application are monitored. At an operation 715, response(s) from the server portion of the networked application to the request(s) from the client portion of the networked application are monitored. At an operation 720, the request-response context is modified based on the request(s). At an operation 725, the request-response context is modified based on the response(s).

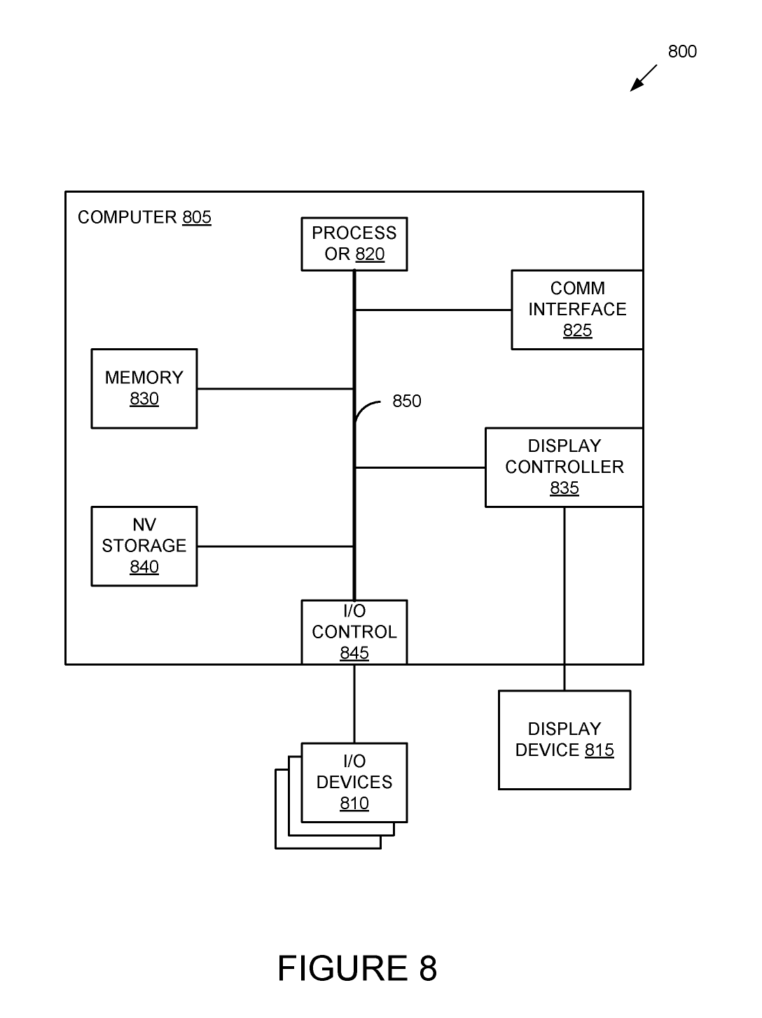

FIG. 8 shows an example of a computer system 800, which can be incorporated into various implementations described in this paper. The example of FIG. 8, is intended to illustrate a computer system that can be used as a client computer system, such as a wireless client or a workstation, or a server computer system. In the example of FIG. 8, the computer system 800 includes a computer 805, I/O devices 810, and a display device 815. The computer 805 includes a processor 820, a communications interface 825, memory 830, display controller 835, non-volatile storage 840, and I/O controller 845. The computer 805 can be coupled to or include the I/O devices 810 and display device 815.

The computer 805 interfaces to external systems through the communications interface 825, which can include a modem or network interface. It will be appreciated that the communications interface 825 can be considered to be part of the computer system 800 or a part of the computer 805. The communications interface 825 can be an analog modem, ISDN modem, cable modem, token ring interface, satellite transmission interface (e.g. “direct PC”), or other interfaces for coupling a computer system to other computer systems.

The processor 820 can be, for example, a conventional microprocessor such as an Intel Pentium microprocessor or Motorola power PC microprocessor. The memory 830 is coupled to the processor 820 by a bus 850. The memory 830 can be Dynamic Random Access Memory (DRAM) and can also include Static RAM (SRAM). The bus 850 couples the processor 820 to the memory 830, also to the non-volatile storage 840, to the display controller 835, and to the I/O controller 845.

The I/O devices 810 can include a keyboard, disk drives, printers, a scanner, and other input and output devices, including a mouse or other pointing device. The display controller 835 can control in the conventional manner a display on the display device 815, which can be, for example, a cathode ray tube (CRT) or liquid crystal display (LCD). The display controller 835 and the I/O controller 845 can be implemented with conventional well known technology.

The non-volatile storage 840 is often a magnetic hard disk, an optical disk, or another form of storage for large amounts of data. Some of this data is often written, by a direct memory access process, into memory 830 during execution of software in the computer 805. One of skill in the art will immediately recognize that the terms “machine-readable medium” or “computer-readable medium” includes any type of storage device that is accessible by the processor 820 and also encompasses a carrier wave that encodes a data signal.

The computer system illustrated in FIG. 8 can be used to illustrate many possible computer systems with different architectures. For example, personal computers based on an Intel microprocessor often have multiple buses, one of which can be an I/O bus for the peripherals and one that directly connects the processor 820 and the memory 830 (often referred to as a memory bus). The buses are connected together through bridge components that perform any necessary translation due to differing bus protocols.

Request Prediction

Request prediction can be used to counteract the effects of increased latency in request-response systems. In distributed applications that use the request-response pattern, performance may degrade when latency is increased (e.g., when used over a WAN). This degradation can be counteracted by using a cache of the responses on the client. In order to ensure that the performance is the same for a series of queries even though latency has increased, the caching system must obey the following inequality:

$$h \geq \frac{2 {l}^{′} + e - 2 l}{2 {l}^{′} + e + s - c}$$

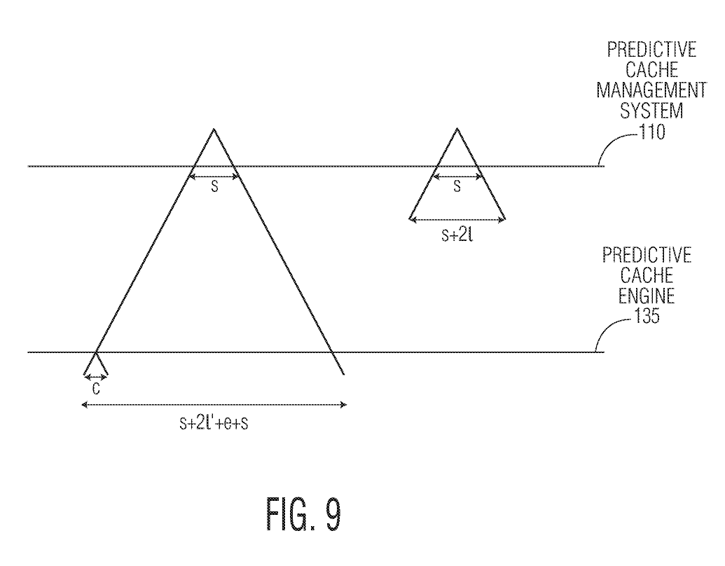

h=Cache hit ratio measured over the series of queries
l=Original latency
l′=Actual latency
s=Time to process request by the service
c=Time to return a cached response
e=Time expense of adding caching infrastructure to process for a full client/server request/response
In an embodiment, the inequality is derived with reference to FIG. 9 as:

hc+(1−h)(2l′+e+s)≦2l+s;

hc+2l′+e+s−2l″h−he−hs≦2l+s;

hc−2l′h−he−hs≦2l−2l′−e;

h(c−2l′−e−s)≦2l−2l′−e;

h≦(2l′+e−2l)/(2l′+e+s−c).

An example of increased latency is when moving a client and server connection from a LAN to a WAN. In such an example l (original latency) would be the LAN latency and l′ (actual latency) would be the WAN latency.

The above-provided formula assumes that the client response processing time is independent of when the response is returned to the client. An example of when this might not be the case is when, as part of processing the response, the client needs to coordinate with other threads. Coordinating with other threads may mean that time saved on one particular query may not decrease the overall time for the series of queries by the same amount.

Effects of Adding Caching

By adding caching to an existing request-response system, bugs may be introduced due to violations of an assumption a client has made that was true for the system without caching. It may also increase the likelihood of a bug being hit if the likelihood of an assumption being violated is increased. Assumptions that a client may make include, for example, time assumptions and consistency assumptions. Time assumptions include:
1. The response was retrieved from the server after the request was made;
2. The response was retrieved from the server at most x milliseconds ago;
3. The response was retrieved from the server at least x milliseconds after the request was made. It's highly unlikely that a client would assume this but in theory it is possible;
4. The response was retrieved at a set point between the request being issued and the response being retrieved. Again it's highly unlikely that a client would assume this but this assumption is included to make this list exhaustive;
5. The response is received within x milliseconds of the request being sent. For example, the request may have a timeout;
6. The response is received at a specified time after the request was sent. It's unlikely a client would assume this although perhaps more likely than time assumption 3 or 4 as some applications may utilize a sleep function on the server;
7. The response is received before it has been retrieved from the server. This assumption is included for the sake of completeness but in reality time travel would be needed to break this assumption; and
8. The sequence of responses for a certain operation come from the database after the operation was requested.
   Consistency assumptions include:
1. Strict consistency;
2. Sequential consistency: If query A came after query B, then any writes that affect A must also be applied to B; and
3. Eventual consistency.

Strict Consistency/time assumption 1—It turns out that strict consistency can be met if Time Assumption 1 is abided by. Performance gains can be made using request prediction even if Time Assumption 1 is insisted on:

With reference to FIG. 9, not only is the next query predicted, but when the next query is likely to be asked for is also predicted. This technique has the possibility of halving delays due to latency, however, in practice doubling the performance would be hard to achieve but hopefully in some situations it would be possible to come close. To predict when a query is likely to come, it could be determined if the query always comes a set time after a previous query. If there is no reliable correlation, the query can be run in less time than the latency and is not too expensive on the server then the query could potentially be continuously run on the server until the query is needed, giving between no performance gain and doubling performance if the timing is right. Queries run immediately after this query could then hopefully be predicted as described above.

Sequential Consistency—An application with no cross-client communication will not be able to tell sequential consistency from strict consistency.

One method of enforcing sequential consistency is to ensure that the responses that the client requests come from the server in the order that they request them. Again, this can be achieved with request prediction but now it is not needed to predict when the request will occur, so this technique should be much more effective.

If responses are reordered but still require sequential consistency, the caching system must enforce sequential consistency itself. This is quite complicated and is not discussed here.

Eventual Consistency—Eventual consistency is met if sequential consistency is abided by, so, a way to optimize specifically for sequential consistency is not specified at this time. Theoretically, a faster model of caching could be found that satisfies it than one that satisfies the stricter sequential consistency.

Time assumption 2: The response was retrieved from the server at most x milliseconds ago. This can be met by simply expiring the cache if it is older than the specified time.

Time Assumption 8: The sequence of responses for a certain operation come from the database after the operation was requested. This assumption may be made when two users of an application (each on a separate client) talk to one another. One user may update the application and say to the other user that if they refresh they should have the updated details. This assumption can be met if sequential consistency is abided by and it is ensured that the first query in each operation does indeed hit the server. This is easily achieved using request prediction.

Request Predictions Schemes

One means of caching is to use request prediction. In an embodiment, requests are predicted by the server before the client issues them and the responses are sent to the client ready for when the client requests it.

Requests are generally made by applications, perhaps influenced by human interaction. Computer applications are typically deterministic and highly predictable. Likewise, patterns can generally be found in human actions that make them to some degree predictable by probabilistic means.

Requests can be divided into three categories, a write, a read, and an isolated write. In an embodiment, a write is a request that changes the state of the service. In an embodiment, a read is a request that does not change the state of the service. In an embodiment, an isolated write is a request that changes some state that is only accessible by a client, a subsection of the client, a session on the client, or a collection of clients. In order to use request prediction for caching, the request must be issued on the server without being requested by the client. As the prediction may be wrong, the caching system must ensure that the request causes no side effects in the event of the request being wrong. For example, a read can be issued with no side effect and an isolated write can be issued with no side effect providing the write can be rolled back. In contrast, a write cannot be issued with no side effect unless the request can be manipulated to be an isolated write and be rolled back without affecting the behavior of the application.

A web site may be chatty with a service such as a database but still perform well in the high latency environment of the Internet. It manages this as the chattiness is between the web server and the database where the latency is low. For example, the browser makes a Get request, the web server queries the database however many times it needs to query the database and renders all the results into a single page, which is then sent to the client. Crucially, the high latency round trip over the Internet is only made once.

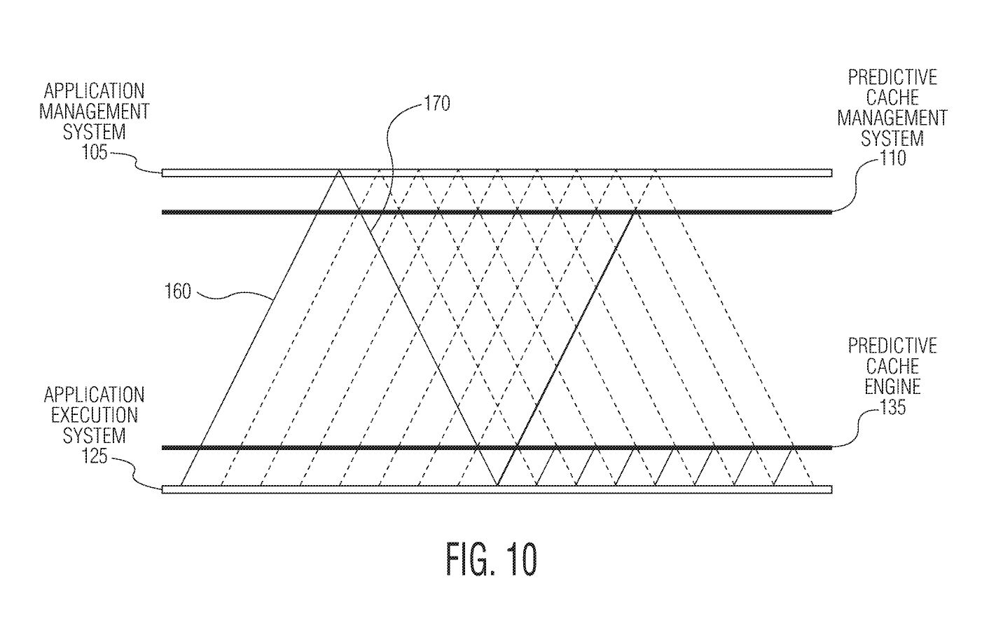

Client server applications are usually not designed to allow the rendering to happen on the server-side. The GUI interaction happens on the client-side and it may make many calls to the database in order to do this. FIG. 10 is a diagram of an example of how predictive caching works for a client server application, streaming the responses to the client rather than waiting for new requests. In particular, FIG. 10 illustrates the application execution system 125, the predictive cache engine 135 on the client-side and the predictive cache management system 110 and the application management system 105 on the server-side. A request 160 is issued from the client-side and a response 170 is issued from the server-side. The predictive cache management system predicts subsequent requests after receiving a request and corresponding responses are held in a cache at the predictive cache engine. When the application execution system issued a request that corresponds to a cached response, the cached response is served from the predictive cache engine, thus eliminating latency associated with the travel time between the client-side and the service side (e.g., 2l′ as shown in FIG. 9). Given the time savings achievable when a request is successfully predicted, the task of predicting requests is key to realizing performance improvements using predictively cached requests

Predictable Streams

In an embodiment, a predictable stream is defined as a series of requests that are predictable and in a predictable order. Requests and responses may overlap. In an embodiment, it is desirable to make request predictions on predictable streams rather than on unpredictable streams. Thus, identifying predictable streams limiting request predictions to only the identified predictable streams can improve the performance when using predictively cached requests. Additionally, in an embodiment, it is desirable to implement prediction learning only on predictable streams in order to focus learning resources on streams that can be successfully predicted. Examples of predictable streams in database (e.g., SQL), web services (e.g., REST), and file systems are described below.

If the application is multithreaded, then the requests that are sent by the application may not be in a deterministic order. Each thread, however, is likely to be deterministic, although this may not be the case if there is a lot of cross thread communication. If the queries from a thread are deterministic, then the set of requests can be called a predictable stream.

Predictable streams are not necessarily bound to threads though, asynchronous architectures may mean each request and each response is handled on a different thread, although the requests are still in a deterministic order.

Humans, although not deterministic, can have a probabilistically predicted order of actions. Humans are generally not good multitaskers so the requests from any one human could be considered a predictable stream.

Predictable streams will typically be synchronous, the response returning before the next request is sent, but not always.

There are many ways to predict application traffic. Some example techniques are described herein. If the methods prove effective, they can be expanded upon to give better predictive power.

Pulse Analysis

The term “pulse” is used herein to mean a series of requests that an application sends to a server that represents some operation in the application. For example, the operation would typically be a user interface (UI) operation such as a button click or opening a form. For pulse analysis to be an effective form of query prediction, applications would need to run a deterministic ordered set of queries for a given operation. This seems to be typical for many applications.

Branches—There may be pulses that are similar to other pulses in that they start with the same set of queries, but at a point (a branch point) they go their separate ways. As an initial implementation, it is suggested that no attempt be made to predict requests at branch points and instead wait for the request to come from the application so it can be decided which branch to go down and predict on from there. Further optimization could be made by predicting at branch points using probabilistic methods.

Pulse Separation—Requests are issued serially inside an application such as a SQL connection (or serially inside a session for multiple active result sets (MARS)), however, a single connection (or session) may represent many pulses, so a way is needed to separate the pulses from one another. When connections are separated, we need to be careful of connection pooling and server process ID (SPID) reuse.

Time separated—In an embodiment, time separation is used to identify separate pulses. Typically, an application can respond much faster than a user, so it is assumed that if the time between returning a response to the application and the application issuing another request is over a certain time limit (e.g., 200 ms, or 200 ms±20 ms), then the new request is part of a new pulse.

Branch separated—A simpler (though potentially less effective) form of pulse separation is to split a pulse when it branches. This approach may be more simple, as it means that each pulse does not branch and the approach requires no measurement of the time between queries (that to do well requires extra notifications between the client and server). It does mean that a pulse is not likely to represent an entire operation as far as the user is concerned, but this simple implementation allows us to test assumptions quicker and can easily be adapted to the time separation model if desired.

Basic Branch separation does have the drawback that it identifies the pulse by the first query (if two pulses start with the same query that will be treated as a branch point and separated). This will make this method fragile to systems with requests that are used in many different parts of the system.

Look-back prediction—Look-back prediction assumes one can predict a query based on the previous N queries. Look-back prediction makes no attempt to gather queries into pulses, but based on the previous request seen, if a pattern can be found, then it will make a prediction. It should offer an advantage over pulse analysis if queries are not separated into operations, but may be less optimal if they are. Put another way, pulse analysis separates probabilistic prediction (e.g., branch points) and deterministic prediction (e.g., between branch points) rather than using a purely probabilistic approach.

In an embodiment, using pulse analysis, deterministic streams can be identified and request prediction can be limited to only those streams that are identified as deterministic streams to improve the hit ratio of cached responses. Additionally, prediction learning can be limited to only those streams that are identified as deterministic streams so that resources consumed by prediction learning are dedicated to those streams that can be most effectively predicted.

Predicting Parameters

Requests can be divided into a statement and zero or more parameters. To predict the request, both the statement and the parameters need to be predicted. If the sequence of statements is predictable, then the next step is to predict the parameters. The parameter may have come from one of the following sources: user input; a constant in the code; a previous response from the server; state held by the client: files, time, registry; and the result of a function acting upon one or more of the above sources. The function is likely to be deterministic.

Parameters may have already been seen by the caching system in one of the following places: a previous request in the series of queries; a previous response in the series of queries; and a constant, the same every time for that statement in that particular place in the series of queries.

Parameter Prediction Techniques

Parameter Constants—The simplest form of parameter prediction. If the value of a parameter never changes we can assume it is a constant.

Parameter Mapping—Parameter mapping is a way of predicting parameters based on a parameter seen on an earlier query in the sequence. In an embodiment, parameters can be systematically numbered in the sequence, bearing in mind one query may have many parameters. A prediction can be made based on the new value of a parameter which has had the same value to the parameter we want to predict in the past. For example, as shown in Table 1, if the following parameters and values have previously been seen:

And now we are trying to predict the value of parameter 4 in the 2nd sequence, then it can be seen that parameter 2 was equal to parameter 4 in the 1st sequence so it can be predicted that the same will be true for the 2nd sequence, namely that parameter 4 is equal to 9.

In a more complicated example, as shown in Table 2, if the following parameters and values have previously been seen:

From table 2, it can be predicted that in the 3rd sequence, parameter 4 will have the value 23, since only parameter 2 has consistently had the same value in the past.

Two sequences may have identical requests but differ by how the parameters are used. If we have a context in which to differentiate the sequences (for example, by seeing which sequence preceded this sequence), then the context can be used to make a prediction. For example, as shown in Table 3, if the following parameters and values have previously been seen:

In an embodiment, a prediction cannot be made without looking at context as none of the first three parameters consistently have the same value as parameter 4. However, if context is taken into account, it can be predicted that in the 5th sequence, parameter 4 will have the value 23 since the 5th sequence has context A and parameter 2 has consistently had the same value for all sequences with context A. A sequence may have many different contexts to consider (previous sequence, sequence before that, user, time of day, etc.). Using this technique we can test the context to see if it is a relevant factor.

Parameter Translation—While parameter mapping is useful for parameters that have already been seen by the caching system, it cannot make any predictions if the parameter has not been seen before and is instead directly from one of the other sources listed above (except source 3, a previous response from the server, since this will always have been seen by the caching system, however, parameter mapping may be chosen for this too as mapping parameters from responses may be inefficient). In an embodiment, parameter translation looks for correlations in much the same way that parameter mapping looks for equal values.

Invariant pairing—A simple form of correlation is to look for invariants for a given value that is to be predicted. For example, as shown in Table 4, if the following parameters and values have previously been seen:

It can be seen for a given value of parameter 4 that parameter 2 is invariant (e.g., for a value of 5 it is always 2 and for a value of 6 it is always 47). Thus, the translation pairs 2→5 and 47→6 can be stored for this particular parameter translation. The correlation may have many causes, including, for example:
1. A deterministic function that acts on the first parameter to produce the second parameter;
2. A relationship from the server (for example, for a database, one parameter may represent a contact ID and the other a company ID and the correlation is that the contact ID is the primary contact for the company.);
3. A deterministic function that acts on a relationship from the server;
4. A deterministic function that acts on the first parameter and other sources to produce the second parameter. The correlation would probably only occur if the other sources have not varied when the sequences were seen (for example, the other source could be the day of the week, or some state held in the client that has not changed); and
5. A coincidence.

For cause 1, it can be expected that the translation will always hold, however, that may not be true for the other causes. For cause 2 and 3, the pair may become invalid when the state of the server is changed (for example, by a write). After the state change, the translation may still hold (e.g., parameter 2 to 4), but with a new pair of values. For causes 2 and 3, the pair could be used for all users of that server and once the pair has expired, it can be expired for all users. For cause 4, there is a similar situation in that the pair may be useful for a while then expire, but in this case the pair may be client specific and the expiry time client specific. For cause 5, there is nothing that can be done apart from use another method to predict the parameter.

External Source Correlation—As mentioned above (source 4) the source of the parameter may come from state on the client such as the time, or values in the file or registry. Using the methods already listed, we can see if any suspected sources correlate with parameter values.

Expiring Values—If all other prediction methods fail but the value of a parameter does seem to stay constant for a while, we can temporarily store the value it has been in order to predict it. The value and it's expiry time may be client specific or applicable to all users.

Sequence Length Prediction

For some services, for example, file systems, the length of a predictable sequence of requests may not be fixed. If this is the case, it may be needed to use algorithms similar to the parameter prediction algorithms to predict the sequence length.

Server Load

Request prediction will increase the load on the server per client when predictions do not come true. Not only will the requests that come from the client hit the server, but the predicted requests that did not come true will too. In an embodiment, a load ratio is expressed as:

Load ratio=2−p (p being the prediction hit ratio)

For maximum performance, multiple requests will need to be predicted in advance without getting any feedback as to whether the first prediction was wrong, as is illustrated in FIG. 10.

Since the success of a later prediction is dependent on the predictions before being correct, if there is uncertainty in each prediction, the uncertainty will compound the further ahead predictions are made.

Load while learning—It is expected that predictions will become more accurate as the prediction engine learns about the application traffic. Predictions do not need to be made in order to learn so the load ratio can be controlled (e.g., limited) by only making predictions when we are confident that our predictions are accurate. However, if load is not an issue, then performance can be increased by making predictions even without certainty to gain performance when they are correct. In an embodiment, learning request-response correlations and populating a database in the prediction engine with the learned request-response correlations is suspended until the learning reaches a learning accuracy threshold.

Load Once Taught—Although there will be no “taught” state, it can be imagined a time when the prediction engine has reached the limit of what it can learn given its current algorithms. For example, the limit is reached when the new traffic data does not change the prediction data. If the predictable streams are at all deterministic, then runs of queries will be seen whereby once one query is known, the rest of the queries are known. There is also likely to be branch points, e.g., points where the next query could be one of a number of queries. There may also be points where it is unclear what query may come next. If no attempt is made to predict at branch points or at points where it is not known which query comes next, then the load ratio will be 1 once the prediction engine has been “taught”. The load could then be allowed to increase by predicting at branch points to increase performance.

Branch Prediction

The prediction techniques mentioned so far are deterministic in that they either come up with a single prediction or no prediction at all. Even if the application is largely deterministic, there are likely to be points where a number of things could happen and it is not known which will happen. Such points where there are multiple choices are referred to as branch points. It is possible to make probabilistic predictions at these points based on past usage.

In an embodiment, to keep the server load ratio as close to 1 as possible, no predictions are made at branch points. However, performance can be improved at the cost of load if predictions are made at branch points.

Single Branch Prediction—One option is to predict the most likely branch. If only the 1st query is predicted in this branch, then it is unlikely to see any performance benefit since one would have to wait for a round trip on the 2nd query rather than on the 1st query so no improvement has been made. Additionally, if the prediction is wrong, then load is increased, so this may not be a good option. To actually improve performance, one needs to predict a number of queries. If the branch prediction is wrong, all the queries predicted will be wrong and load will have increased. If the branch prediction is correct, then load will not increase and there may be a significant performance increase.

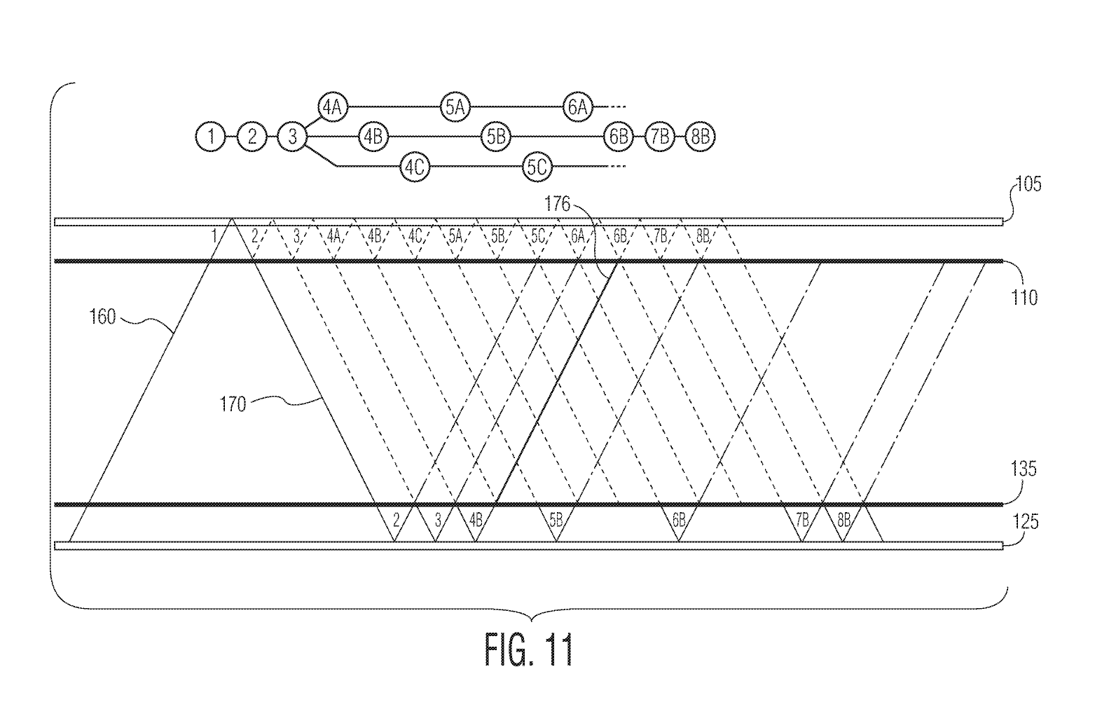

Multiple Branch Prediction—Another option is to predict multiple branches. This could be all possible branches at this point or just the most likely branches. In the example illustrated in FIG. 11, three different branches are predicted. After query 3, it could be query 4A, 4B, or 4C. In order to get performance gains, more queries need to be predicted on these branches. With reference to FIG. 11, it can be seen that predictions 4A, 5A, and 6A are made on branch A and also queries from the other branches are made. In particular, predictions 4B, 5B, 6B, 7B, and 8B are made on branch B and predictions 4C and 5C are made on branch C. As illustrated in FIG. 11, query 7A is not predicted because by then a notification has been received from the client (marked as notification 176 in FIG. 11) that path B was taken and so there is no point in predicting any more queries on branch A or on branch C. Thus, once a branch can be determined on the server side, further queries along the not-chosen branches (e.g., branches A and C) are not made. Note that the client receives responses in the order that they hit the database. This is essential to maintain sequential consistency.

Service Types

To implement request prediction on a service type (e.g., databases, web services, and files systems), the following information may be needed:
1. A way of intercepting requests and responses;
2. A way of separating requests;
3. A way of separating responses;
4. A way of separating any other traffic that may be confused with requests or responses;
5. A way of processing the request message to tell if the request is a read or a write;
6. A way of linking responses to requests;
7. A way of grouping queries into predictable streams; and
8. A way of separating requests into statements and parameters.
   With the following information, further optimizations can be made:
1. A way of processing the request message to tell if the request is an isolated write; and
2. A way of rolling back an isolated write.

Databases

In an embodiment, request prediction can be implemented for a database application, such as SQL Server. TCP can be used as a way of intercepting requests and responses. Tabular data stream (TDS) Header Parsing (and MARS parsing) can be used as a way of separating requests and separating responses. All the TDS Packet Types can be used as a way of separating any other traffic that may be confused with requests or responses. However, only Attentions are out-of-band and should not be considered as requests or responses. Retrieving and parsing the ShowPlanXML can be used to process the request message to tell if the request is a read or a write. In an embodiment, this will require remote procedure call (RPC) to SQLBatch translation for RPC statements (see below). In each MARS session, the response will follow its associated request before any new requests are made. In a non-MARS TDS connection, all queries should be considered to be in the same MARS session. This knowledge can be used to link responses to requests. In an embodiment, a way of grouping queries into predictable streams is dependent on whether the traffic is MARS traffic or non-MARS traffic. With non-MARS traffic, each TDS connection can be considered a predictable stream. With MARS traffic, each MARS session may be a predictable stream or potentially the whole TDS connection will be a predictable stream. There are a variety of ways of separating requests into statements and parameters, each with various pros and cons. For example, RPC parsing and transact-SQL (TSQL) parsing can be accurate but requires intimate knowledge of the RPC protocol and the TSQL syntax. In another example, Diff separating may have an issue with keeping unique identifiers for parameters, but one could use parameter position, but this is not so good if message changes size. Diff separating may have lots of data to persist (maybe with a database) and may be hard to work out if a message changes size. In another example, numeric separating may only work with numeric parameters and RPC would require being turned into a SQLBatch statement. In an embodiment, the time expense of the caching infrastructure, e (as described with reference to FIG. 9), would include the overhead of messages passing through the caching elements (e.g., the predictive cache engine 135 on the client side and/or the predictive cache management system 110 on the server side) four times (request and response on both the client-side and server-side). It may also include overhead such as issuing and processing ShowPlanXMLs if they are done in-line. In an embodiment, there is an RPC to SQLBatch conversion. In an embodiment, this is automatically done by an SQL profiler. In an embodiment, SQL can do this in line. Request prediction as described above is also applicable to other databases.

Web Services

In an embodiment, request prediction can be implemented for a web service, such Representational State Transfer (REST). TCP can be used as a way of intercepting requests and responses. In an embodiment, there is only one request and response per TCP connection. Requests are the server bound part and responses are the client bound part. There is no other traffic so requests and responses are inherently separated from any other traffic that may be confused with requests or responses. In an embodiment, HTTP parsing can be used to see if the request is a Post, a Get, a Put, or a Delete. If the request is a Get, then the request can be categorized as a read, otherwise, the request is categorized as a write. In an embodiment, requests and responses are linked be virtue of being in the same TCP connection. As stated above, it is desirable to group queries into predictable streams. In an embodiment, if the application is single threaded with synchronous REST calls, then one can assume all traffic from the client is in a single predictable stream. If the application is multithreaded with synchronous REST calls, then once could intercept the call (e.g., with an application virtualization layer) and attach a thread ID to the request message. The thread ID would then define the predictable stream. If the application is single threaded with asynchronous REST calls, then one can assume all traffic from the client is in a single predictable stream. If the application is multithreaded with asynchronous REST calls, then one could potentially link the response of one thread to the request of the next by thread ID using an application virtualization layer to form predictable streams.

File Systems

In an embodiment, request prediction can be implemented for a file system. File system API hooking with an application virtualization layer can be used as a way of intercepting requests and responses. Requests and responses can be separated by the individual API calls. As a way of separating any other traffic that may be confused with requests or responses, one could filter out API calls that have no return type. In an embodiment, determining if a request message is a read or a write could be based on call type and in some cases the parameters of the call. Responses could be linked to requests based on the API call. In an embodiment, queries are grouped into predictable streams by thread. In an embodiment, requests are separated into statements and parameters within the API calls. Some parameters may be included as part of the statement if the parameters change the behaviour of the call.

Other Topologies

In an embodiment, the request prediction caching techniques may be applicable to other topologies, such as servers also making requests to clients, multiple servers, cross-client communication, and in a very general case, to any distributed system.

In an embodiment, the term “cache” refers to a response that can be returned to a request faster than going to the source. How predictive caching works does not meet some conventional definitions of cache such as “a component that stores data so future requests for that data can be served faster” since the response may be “stored” on the client after the request has been made (but still before the response would have been available had the cache not been there). In an embodiment, the term “query” refers to a request response pair. In an embodiment, the term “session” refers to a synchronous series of queries that are deemed to be connected in some way.

Network computers are another type of computer system that can be used in conjunction with the teachings provided herein. Network computers do not usually include a hard disk or other mass storage, and the executable programs are loaded from a network connection into the memory 830 for execution by the processor 820. A Web TV system, which is known in the art, is also considered to be a computer system, but it can lack some of the features shown in FIG. 8, such as certain input or output devices. A typical computer system will usually include at least a processor, memory, and a bus coupling the memory to the processor.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Techniques described in this paper relate to apparatus for performing the operations. The apparatus can be specially constructed for the required purposes, or it can comprise a general purpose computer selectively activated or reconfigured by a computer program stored in the computer. Such a computer program can be stored in a computer readable storage medium, such as, but is not limited to, read-only memories (ROMs), random access memories (RAMs), EPROMs, EEPROMs, magnetic or optical cards, any type of disk including floppy disks, optical disks, CD-ROMs, and magnetic-optical disks, or any type of media suitable for storing electronic instructions, and each coupled to a computer system bus.

For purposes of explanation, numerous specific details are set forth in order to provide a thorough understanding of the description. It will be apparent, however, to one skilled in the art that implementations of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

The language used herein has been principally selected for readability and instructional purposes, and it may not have been selected to delineate or circumscribe the inventive subject matter. It is therefore intended that the scope be limited not by this detailed description, but rather by any claims that issue on an application based hereon. Accordingly, the disclosure of the implementations is intended to be illustrative, but not limiting, of the scope, which is set forth in the claims recited herein.

What is claimed is:

1. A method comprising:
identifying a networked application having a client portion and a server portion coupled to the client portion over a network characterized by a first latency;
identifying a database used to store activity related to the networked application is identified;
identifying a request-response context of the networked application;
using the request-response context to predict requests the networked application is likely to make using the database;
generating responses to the requests;
creating a cache having the requests and/or the responses stored therein; and
providing the cache to a predictive cache engine coupled to the client portion of the networked application by a computer-readable medium that has a second latency less than the first latency.

2. The method of claim 1 wherein pulse analysis is used to predict a request that the networked application is likely to make.

3. The method of claim 2 wherein a new pulse is identified when the time between issuing requests exceeds a threshold.

4. The method of claim 3 wherein the threshold is approximately 200 ms.

5. The method of claim 3 further comprising learning request-response correlations on a per-pulse basis.

6. The method of claim 1 further comprising learning request-response correlations and populating the database with the learned request-response correlations, and further comprising suspending predictions until the learning reaches a learning accuracy threshold.

7. The method of claim 1 further comprising predicting multiple requests along multiple branches that correspond to a request.

8. The method of claim 1 further comprising predicting multiple requests along multiple branches that correspond to a request until a notification of a taken branch is received.

9. A method comprising:
identifying a networked application having a client portion and a server portion coupled to the client portion over a network characterized by a first latency;
identifying a database used to store activity related to the networked application is identified;
identifying a request-response context of the networked application;
using the request-response context to predict requests the networked application is likely to make using the database;
using the request-response context to predict responses to the requests;
creating a cache having the requests and/or the responses stored therein; and
providing the cache to a predictive cache engine coupled to the client portion of the networked application by a computer-readable medium that has a second latency less than the first latency.

10. A method for identifying a request-response context of a networked application, the method comprising:
receiving an identifier of a networked application having a client portion and a server portion coupled to the client portion by a network;
identifying actions to be taken by the networked application;
using the actions to assign a request-response context to the networked application according to one or more predefined request-response contexts;
determining whether or not to modify the request-response context based on the actions;
using the request-response context to predict requests from the client portion to the server portion; and
using the request-response context to predict responses from the server portion to the requests from the client portion.

11. A method for modifying a request-response context of a networked application, the method comprising:
identifying a request-response context of a networked application having a client portion and a server portion, where the request-response context forms a basis of predictive caching related to the networked application;
monitoring requests from the client portion of the networked application;
monitoring responses from the server portion of the networked application to the requests from the client portion of the networked application;
modifying the request-response context based on the requests;
modifying the request-response context based on the responses.
